(19) United States
(12) Patent Application Publication
(10) Pub. No.: US 2026/0319773 A1
(43) Pub. Date: Oct. 15, 2026

(54) ORDERED CHOICE CONSTRUCTS

(71) Applicant: Zoho Corporation Private Limited, Kanchipuram District (IN)

(72) Inventors: Sridhar Vembu, Tenkasi (IN); Akshhayaa S, Kanchipuram District (IN)

(73) Assignee: Zoho Corporation Private Limited, Kanchipuram District, TN (IN)

(21) Appl. No.: 19/460,458

(22) Filed: Jan. 27, 2026

Related U.S. Application Data
(60) Provisional application No. 63/811,591, filed on May 24, 2025.
(60) Provisional application No. 63/904,762, filed on Oct. 24, 2025.

(30) Foreign Application Priority Data
Apr. 11, 2025 (IN) 202541035670
Sep. 11, 2025 (IN) 202541086478

(51) Int. Cl. G06F 8/41

(52) U.S. Cl. CPC G06F 8/43

(57) ABSTRACT

A programming language and compiler support a conditional branching construct defined such that multiple conditions are used to evaluate a variable. An extension outside the definition of the construct includes a reference to the construct and another condition to evaluate the variable. The extension can include an order indicator that determines the execution sequence of the condition in the extension relative to the conditions of the construct.

### CROSS REFERENCE TO RELATED APPLICATIONS

This application claims priority to U.S. Provisional application 63/811,591 to Sridhar Vembu and Akshhayaa S filed 24 May 2025 and entitled “Ordered Choice Construct” and to U.S. Provisional application 64/904,762 to Sridhar Vembu and Akshhayaa S filed 24 Oct. 2025 and entitled “Ordered Choice Construct,” both of which are incorporated herein by reference.

### FIELD OF THE INVENTION

Embodiments of the present disclosure are related, in general, to computer programming languages and methods for compiling conditional branching constructs.

### BRIEF DESCRIPTION OF THE DRAWINGS

The present invention is exemplified, rather than limited, by the figures in the accompanying drawings, where like reference numbers indicate similar elements.

FIG. 1 provides an example of source code 100 in a file with an illustrative definition 105 of an ordered-choice construct used for water management.

FIG. 2A is a flowchart 200 illustrating how a compiler compiles source code to manage extensions of ordered-choice constructs that occur outside of the definitions of those constructs.

FIG. 2B is a flowchart 240 illustrating a method of compiling source code 245.

FIG. 3 depicts a source-code snippet 300 in a file “File 1: water management.”

FIG. 4A depicts a first source-code snippet 400 in File 1 defining an ordered-choice construct 405 with an abstract condition/choice (missing expression).

FIG. 4B is a flowchart 450 illustrating a method of evaluating ordered-choice constructs while compiling source code (455).

FIG. 5 is a flowchart 500 illustrating how a compiler can compile ordered-choice constructs in source code 505.

### DETAILED DESCRIPTION

A computer program comprises a series of statements written in a programming language. Human developers and programmers write computer programs using high-level languages that are highly abstracted from computer hardware to make programming easier. A compiler, itself a computer program, translates so-called “source code” written in a high-level programming language into a lower-level language, such as machine code, to be executed by a computer.

Source code includes diverse types of statements that define the actions for which a program is designed. These include expressions and control-flow statements. An expression is a combination of operands (values, variables, etc.) and operators that evaluate to a single value and is a fundamental building block of code used to perform calculations, comparisons, or manipulate data. Control-flow statements dictate the sequence in which a program's operations are executed based on certain conditions. Examples of control flow statements include conditional statements, loop or iterative statements, and other flow-control mechanisms.

A programming language and compiler support a conditional branching construct, an “ordered-choice construct,” that allows developers to extend the construct to include conditions outside of the ordered-choice construct within the same or different file. An ordered-choice construct can be defined within a type, struct, function, iterator/loop, or main body of a program and within another construct. Developers can add a condition or conditions to the ordered-choice construct without modifying the ordered-choice construct. The definition of the ordered-choice construct can thus be maintained while allowing developers to adapt or enhance the ordered-choice construct.

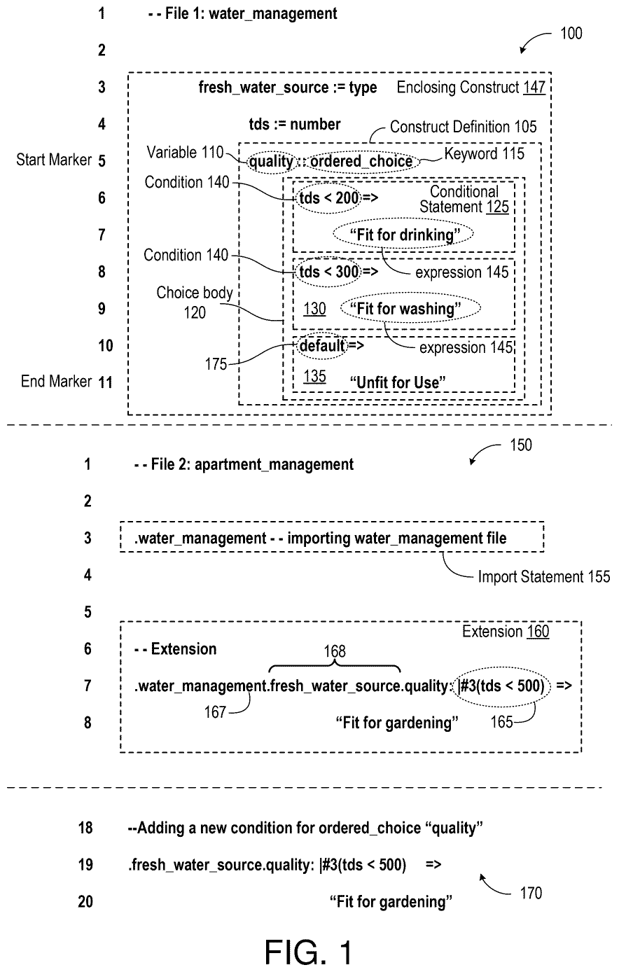

FIG. 1 provides an example of source code 100 in a file with an illustrative definition 105 of an ordered-choice construct used for water management. In this context, a file is a named collection of stored data, containing source code, instructions, or resources for compilation. Files are discrete units of data, like a single document, identified by a file name and extension (e.g., “.c” or “java” for source files for the C or Java programming languages). Compilers can associate files with logical units that inherently create separate namespaces to avoid naming conflicts with other parts of the code.

The ordered-choice construct of definition 105 is a conditional branching construct that includes an ordered-choice construct variable 110 (quality), a construct keyword 115 (ordered_choice), and a choice body 120 that in turn includes three conditional statements/blocks 125, 130, and 135. Choice body 120 determines a value of choice-construct variable 110 from one of conditional statements 125, 130, and 135. Each conditional statement includes a condition 140 and a corresponding expression 145. A condition comprises a Boolean expression that evaluate to either true or false. The ordered-choice construct of definition 105 is to evaluate water quality taking as input a number indicative of the quality “total dissolved solids” (tds). Per conditional statement 125, if tds<200, the water under consideration is deemed to be “Fit for drinking.” If tds<300, conditional statement 130 produces “Fit for washing.” Values of tds outside of the considered ranges are evaluated as “Unfit for Use” by default. For an ordered-choice construct, the execution order of conditional statements is specified by a developer. The execution order may be specified implicitly as the order in which the conditional statements are listed. In another embodiment, the order may be specified explicitly using a symbol signifying the order e.g. a number, an alphabet. The compiler executes those conditional statements in the order specified at runtime.

Construct definition 105 is within the syntactic boundaries of an enclosing construct 147 that provides a type definition (line 3) and a field for tds as a number (line 4). An enclosing construct is a syntactic structure that surrounds or contains other code elements and can be at least one of a type, struct, function, or nested ordered-choice construct. An enclosing construct defines the scope, context, or hierarchy in which the enclosed elements are declared or defined.

A software developer may want to extend or otherwise modify the ordered-choice construct of definition 105. For example, the water-management file of FIG. 1 may be extended to accommodate so-called “gray water” that is fit for gardening but not for drinking or washing. The example of FIG. 1 allows such extensions to be made outside the original ordered-choice construct of definition 105, allowing developers to maintain the integrity of definition 105 while affording flexibility.

FIG. 1 includes a snippet of source-code 150, part of a file with an import statement 155 and an extension 160 that extends the functionality of the ordered-choice construct from outside construct definition 105. In this context, a “construct” is a building block of a programming language, such as a class, function, or data structure. Extension 160 modifies the capability of the construct from outside definition 105, or the visibility boundary of the construct, thus allowing developers to adapt or enhance the construct without modifying the original definition or file.

Import statement 155 is part of a second file, File 2: apartment_management, that imports the ordered-choice construct of definition 105 with reference to the file File 1: water_management. In this example, extension 160 in source-code 150 adds a condition 165 in which for tds<500 water is considered “Fit for gardening.”

An ordered-choice construct can be extended outside of the construct's definition by adding a new conditional statement that includes a condition and other information as “indicator:|#k(new-condition)”. An indicator 167 in the new conditional statement includes at least one direct or indirect reference to the ordered-choice construct of definition 105. In one scenario the reference may be an identifier 168 associated with enclosing construct 147. In another scenario, the reference may be an identifier or a symbol associated with the ordered-choice construct. While not shown in FIG. 1, such an identifier or a symbol may be a part of definition 105. In essence, the at least one reference in the indicator helps the compiler in the identification of an extension of the construct outside the definition of the construct. Indicator 167 also includes “quality,” which refers to the relevant construct variable 110; “|#” indicates the ordered-choice construct; and an order indicator “k” represents the execution order of condition 165 relative to the other conditional statements 126. The “new-condition” denotes a condition of the new conditional statement. The extension may also include an associated expression. The indicator can also include at least one of a type name or a function name.

The extension of ordered-choice construct defined within a type is given in File 2 of source code 150 with its respective indicator given as “.water_management.fresh_water_source.quality”. If the ordered-choice construct is defined within a function “find_quality”, then the indicator in the extension can be given as “find_quality.quality”. An ordered-choice construct can be nested within another ordered-choice construct, where an indicator for the extension of the inner construct includes a nested ordered-choice-construct variable and the respective condition within which the inner construct is defined. The inner construct “quality” is defined within a specific condition (say, second condition which is “2(a>2000)”) of another ordered-choice construct “concat_quality” in the source code. In such a case, the extension of “quality” has the indicator “concat_quality.|#2(a>2000).quality”, where “concat_quality” is the ordered-choice construct variable of the outer construct, “|#” represents the ordered-choice construct and “2(a>2000)” is the second condition of outer ordered-choice construct within which “quality” is defined. In the case of extension done in a different file, the indicator also includes a file name.

Condition 165 is formatted to designate the order of the new condition among conditional statements 125, 130 and 135. Order k is three for condition 165, so condition 165 is evaluated third in the list of conditions. In a specific embodiment, the value of k for a condition should not overlap with other conditions and should be a consecutive number to its immediately previous condition order.

The ‘k’ in the new conditional statement represents the order of the condition evaluation. The value of k can modify the execution order of conditional statements defined within the construct definition and the new conditional statements in the extension. The compiler generates an execution sequence for the ordered-choice construct based on the k value in the IR. The conditional statements are executed sequentially according to the generated execution sequence at runtime.

In one embodiment, the “k” value of the new conditional statement can be the next consecutive value to the maximum order of the conditional statement within the construct definition. Since “quality” includes two conditional statements in this example, other than the default, the maximum order is 2. Hence, in the extension, the “k” value of the new conditional statement should be 3. In another embodiment, the “k” value of the new conditional statement can overlap with an existing order or can be any value greater than the maximum order of conditional statements within the construct definition. The compiler generates a corresponding execution sequence for the conditional statements within the construct definition and in an extension based on the “k” value.

In a specific implementation, where the “k” value of the new conditional statement overlaps with the existing order, the compiler generates an execution sequence replacing the conditional statement having the same “k” value (order) with the new conditional statement. In one embodiment, the compiler validates if the new condition in the extension for replacement is inclusive of the condition to be replaced within the construct definition. The new condition should handle more cases or encompass all cases of both the old condition and the new condition. The new condition should not handle fewer cases because the next choice after the new condition may not be able to handle more. In one embodiment, the default case of an ordered choice construct is an “error” case. Hence, when amending a construct with a new condition to replace an old condition, the new condition is not allowed to increase the errors thrown. In other words, the new condition cannot be non-inclusive of the old condition and let the default handle the slack. The compiler validates if the new condition is non-inclusive of the old condition or cannot handle more cases than the old condition. In a specific implementation, the compiler generates a message if the validation fails and the old condition is not replaced with the new condition.

In another specific implementation, where the “k” value of the new conditional statement overlaps with the existing order, the compiler generates an execution sequence in which the new conditional statement is placed after or before the conditional statement that has the same “k” value (order) within an ordered-choice definition.

FIG. 1 also includes an ordered-choice extension 170 within the same file File 1 as the ordered-choice construct of definition 105. The ordered-choice construct “quality” is extended within File 1, and a new conditional statement is defined in lines 19 and 20 outside of the ordered-choice construct of definition 105.

An extension can be created by importing the conditions of an ordered-choice construct into an extended file. The conditions of ordered choice are imported by importing an ordered-choice defined file (oc_defined_file) in an extended file. For example, the ordered choice “quality” defined in “water_management” file is extended with new condition “#3” in an “apartment_management” file. In this embodiment, the default condition in the ordered choice cannot be replaced by the developer in any of the extended files. If a default condition (“#last”) is provided in oc_extended_file, then the compiler produces a message, such as an error, warning, or an alert. The definition of ordered-choice construct “quality” is present in type “fresh_water_source” of “water_management” file. Hence, line 7 of source code 150 includes the indicator as “.water_management.fresh_water_source.quality” for the new conditional statement with condition “tds<500” in extension 160 of the ordered-choice extended file.

Ordered-choice constructs are normally defined between some form of marker or markers in the source code. In compiling source code 100, the compiler encounters keyword 115 (line 5), which specifies sequential execution and serves as a start marker for the ordered-choice construct of definition 105. An end marker (line 11) is not explicit but is the end of the indented list of conditional statements 125, 130, and 135. The construct body, the body of the ordered-choice construct of definition 105, is defined between the start and end markers. Extension 160 is outside the start and end markers and thus external to the body of the ordered-choice construct of definition 105. Start and end markers can be or include e.g. curly braces, parentheses, indentations, brackets, and keywords.

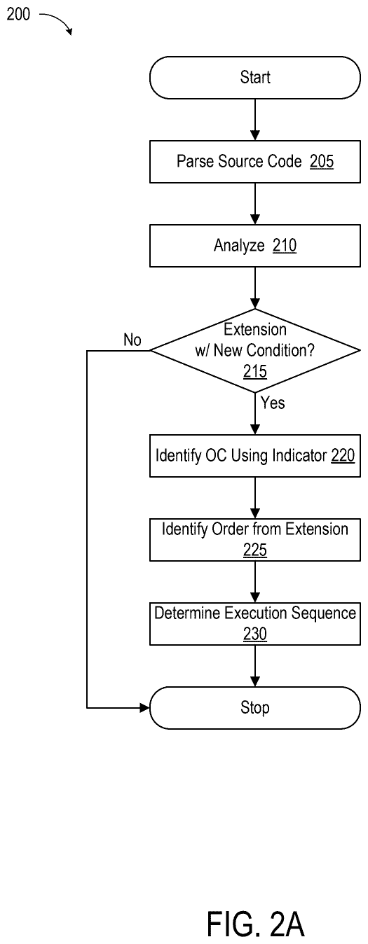

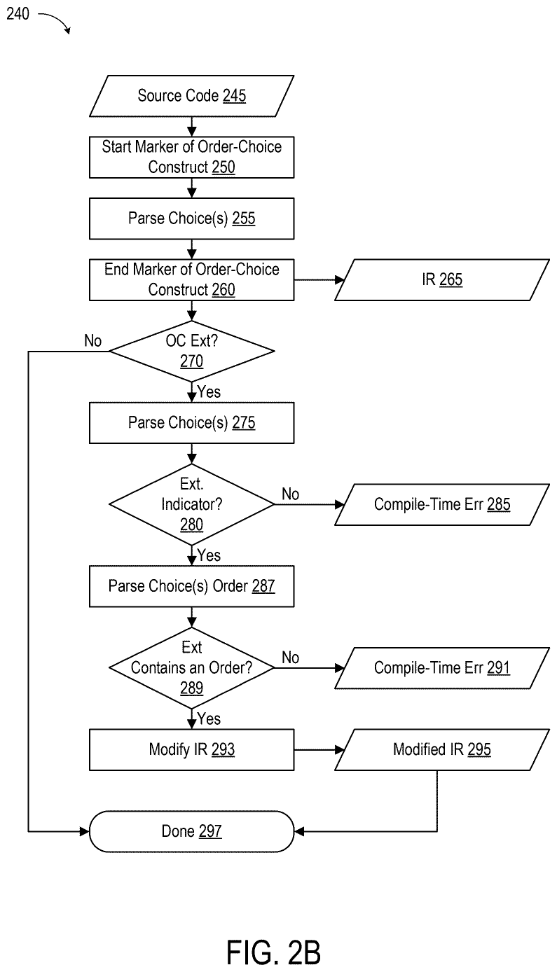

FIG. 2A is a flowchart 200 illustrating how a compiler compiles source code to manage extensions of ordered-choice constructs that occur outside of the definitions of those constructs. The compiler starts by parsing the source code (205), which breaks down the source code into a structured representation (like a syntax tree). The compiler next analyzes the structured representation (210) to check for syntactic and semantic correctness, often in multiple passes. Per decision 215, if in parsing or analyzing the compiler encounters an ordered-choice extension, the compiler identifies the corresponding ordered-choice construct using the indicator included in the extension (220), identifies the execution order for the conditions in the extension (225), and determines the execution sequence of the choices of the ordered-choice construct and extension using the execution order (230). The compiler can then continue the compiling process for any remaining source code to generate executable output.

The compiler expects a “default” condition to be defined for any ordered-choice construct when developer-specified conditions (excluding any default) do not cover all the cases and throws an error if this expectation is unmet. In ordered-choice extensions, the compiler verifies that the newly specified conditions and the conditions within the construct definition cover all cases. If all cases are covered, then the compiler does not include the default condition in the IR. Otherwise, the compiler includes the default condition in the IR.

Returning to FIG. 1, conditions 140 and inter-file extension 160 do not cover all cases so the compiler expects a default condition to be defined for the ordered-choice construct, such as by default 175 in line 10 of source code 100. Likewise for the intra-file extension 170. Hence, the compiler retains the default condition while generating an IR of the extended ordered-choice construct.

The ordered-choice construct of definition 105 of FIG. 1 can be modified by an extension. An import statement 155 imports conditional statements 125, 130, and 135 from the ordered-choice construct of definition 105 and adds them to a fourth conditional statement in which water characterized as having tds<500 is deemed “Fit for gardening” (.water_management.fresh_water_source.quality:|#3(tds<500)=>“Fit for gardening”). The fourth condition includes a specified order “#3” instructing the compiler to create an ordered-choice construct with extension considered third. The fourth condition in extension 160 covers the full range of default condition 135 so the compiler omits the default condition when creating an IR of the extended ordered-choice construct.

Conditional statements in ordered-choice constructs require a condition and an expression to be assigned to a variable if the condition is met. Compilers in accordance with some embodiments support source code with ordered-choice constructs that are missing one or more of these elements. For example, an ordered-choice construct can be defined with an abstract conditional statement missing an expression (an ordered-choice construct with an abstract expression) or missing a condition (an ordered-choice construct with an abstract condition). An ordered-choice construct with an abstract condition or an abstract expression is referred to as an “abstract ordered-choice construct.” Abstract ordered-choice constructs can be extended within a file or in a different file(s) to provide the missing element(s).

FIG. 2B is a flowchart 240 illustrating a method of compiling source code 245. The method supports ordered-choice constructs and their extension within the same or a different file. A compiler (not shown) encounters a marker (250) of an ordered-choice construct having a construct body. In parsing the body, the compiler encounters one or more conditional statements (255) before coming to an end marker denoting the end of the ordered-choice construct (260). The start and end markers delimit the construct body and can be used to distinguish conditions within the construct definition and the extension.

Having parsed the ordered-choice construct, the compiler can issue an intermediate representation (IR) of the ordered-choice construct, an IR 265. The compiler then continues compilation until it encounters an extension of the ordered-choice construct outside the construct definition. Per decision 270, if an extension is found the compiler parses the extension to find one or more conditional statements (275) that apply to the ordered-choice construct of steps 250, 255, and 260. Per decision 280, if the parsed extension lacks a valid indicator for that ordered-choice construct, the compiler issues an error message 285. If the extension includes the indicator, the compiler orders the extended choice per the k value (step 287). Per decision 289, if the extension lacks an order, the compiler throws an error 291 remarking e.g. “Order required for the condition.” If the extension includes an order, the compiler modifies IR 265 (293) to incorporate the ordered-choice extension and thus form a modified IR 295. Compilation of the order-choice construct and its extension are thus finished (297). The compiler can also issue an IR for an ordered-choice construct after parsing the construct definition and any of its extensions.

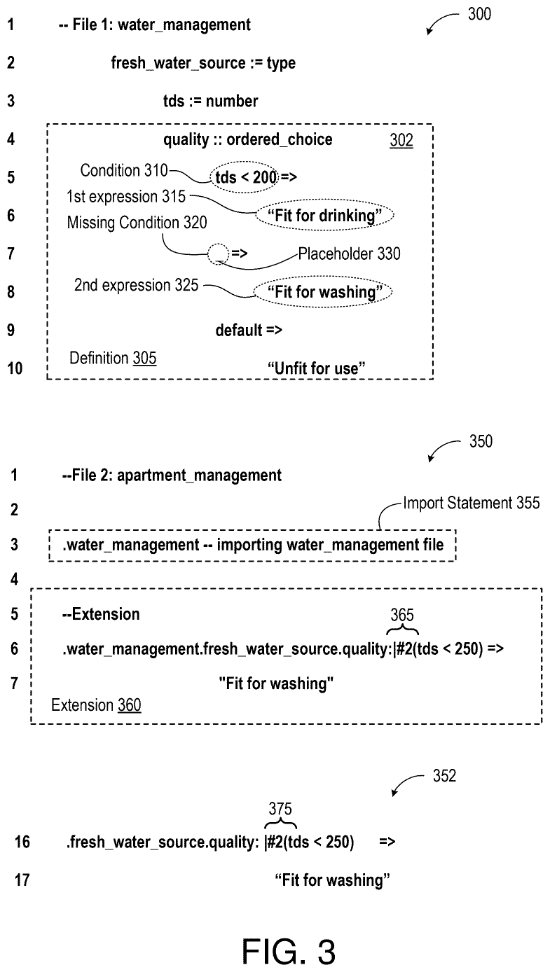

FIG. 3 depicts a source-code snippet 300 in a file “File 1: water management.” Snippet 300 defines an ordered-choice construct 302 with a construct definition 305 having two conditional statements, a first conditional statement with a condition 310 and an expression 315 and a second conditional statement with an abstract (missing) condition 320 and an expression 325. Abstract condition 320 includes a placeholder 330 indicating the need and location for a condition. FIG. 3 also includes source-code snippets 350 and 352 that illustrate extensions that provide the missing condition outside of or within the same file.

Source-code snippet 350 in a file “File 2: apartment management” references File 1 with an import statement 355. An inter-file extension 360 provides the missing condition identified by placeholder 330 in definition 305. Extension 360 supplies the missing condition as tds<250, “Fit for washing”, and includes a specified order “2” (365).

Source-code snippet 352 is part of file File 1 and includes an intra-file extension that provides the missing condition identified by placeholder 330 in definition 305. Like the example of the intra-file extension of snippet 350, inter-file extension 352 supplies the missing condition as tds<250, “Fit for washing”, and includes the specified order “2” (375).

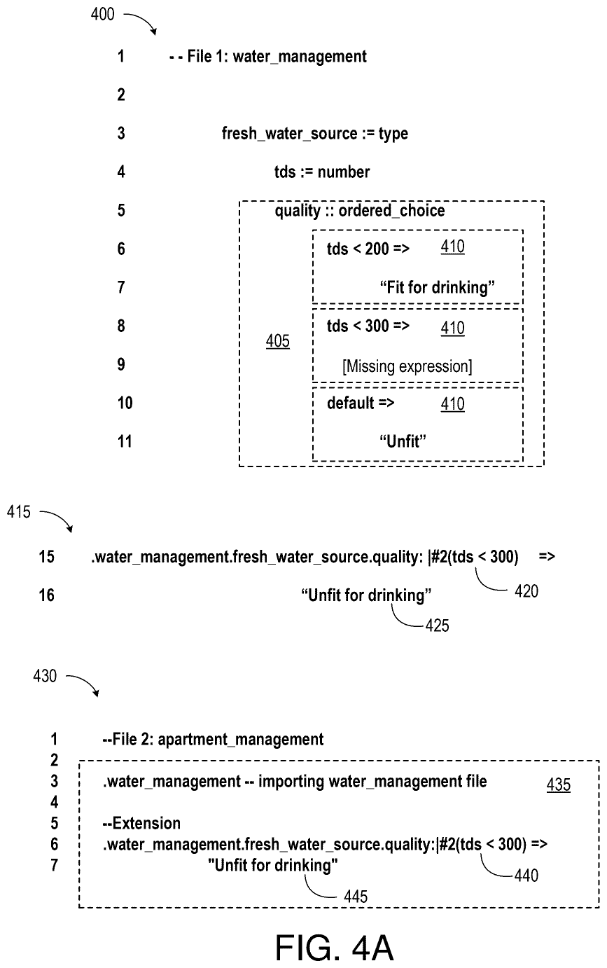

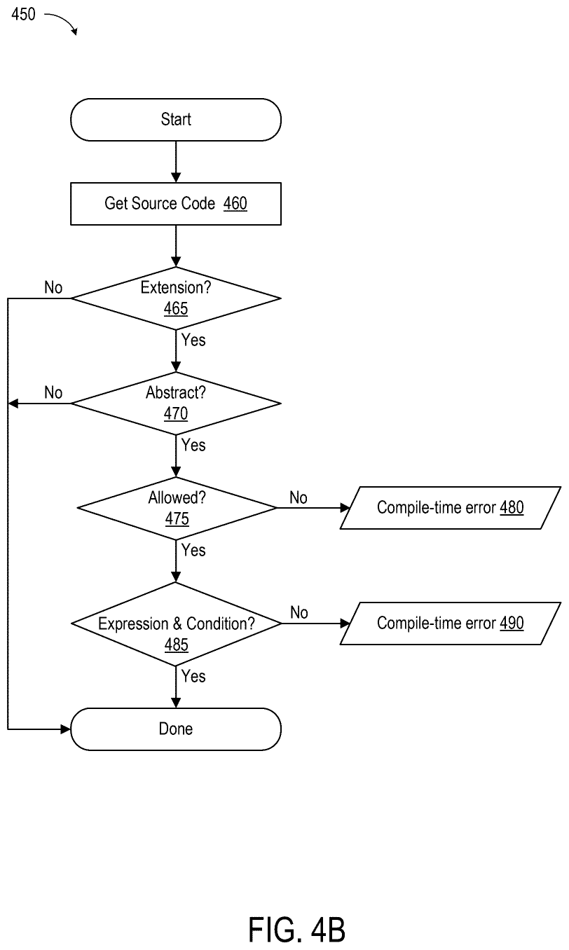

FIG. 4A depicts a first source-code snippet 400 in File 1 defining an ordered-choice construct 405 with an abstract condition/choice (missing expression). In particular, the second of three conditional statements 410 is missing an expression. Abstract ordered-choice constructs are extended within a file or in a different file(s) to define an expression for a conditional statement having a missing/abstract expression. A second source-code snippet 415 defines an extension of construct 405 within File 1 with a condition 420 matching the conditional statement with the missing expression. Expression 425 is defined in the extension for the condition (tds<300). A third source-code snippet 430 extends the ordered-choice construct “quality” in a different file with a new conditional block 435 in a different file (File 2) and with a condition 440 and an expression 445. The new conditional block 435 is defined outside of the ordered-choice construct definition.

The compiler checks whether an extension of any abstract ordered-choice construct is allowed. In a specific implementation, this check verifies whether the symbol “::” is used as an extensibility indicator in an abstract ordered-choice construct definition. If the symbol is not “::”, then the compiler generates a compile-time error and asks the developer to use the “::” symbol to make an abstract ordered-choice construct extensible. In another embodiment, if the symbol is not extensibility indicator “::”, then the compiler throws an error for a missing expression or condition and asks the developer to define missing expression or condition. In a specific implementation, the compiler asks the developer to define a missing condition or expression of a conditional block instead of “_” in the abstract ordered-choice construct.

In one embodiment, for an abstract condition, the compiler searches for an extension with the same expression as the abstract condition. For an abstract expression, the compiler searches for an extension with the same conditional statement as the abstract expression. The compiler can modify the value of “k” in the extension to change the execution sequence of conditional statements in some embodiments.

The compiler can throw a compile-time error alerting to a missing condition or expression when it encounters an access to an abstract ordered-choice construct. For example, any access statements of the “quality” abstract ordered-choice construct results in an error. The abstract ordered-choice construct can be used by extending it within a file or in different files and providing definitions to abstract expressions and conditions.

FIG. 4B is a flowchart 450 illustrating a method of evaluating ordered-choice constructs while compiling source code (455). For abstract ordered-choice extensions within a file or files, if the compiler encounters an ordered-choice extension (decision 465), it checks whether the extended ordered-choice is an abstract ordered-choice construct (decision 470); if so, then the compiler checks if an extension of the abstract ordered-choice construct is allowed (decision 475). If an extension is not allowed, then the compiler issues an error message 480 (e.g., “Extension of abstract ordered-choice construct not allowed”). The abstract ordered choice is either made extensible (e.g., making the symbol as “::” in ordered-choice construct definition) or a complete definition of ordered choice is provided (e.g., providing an expression or a condition to abstract condition or abstract expression of conditional blocks).

If an ordered-choice extension is allowed, then the compiler verifies whether the extension includes a condition for an abstract condition and an expression for an abstract expression (decision 485). If an ordered-choice extension does not include definitions to abstract expression and condition, then the compiler issues a compile-time error message 490 requiring that the ordered-choice construct be extended to define the missing condition or expression (e.g. “Defining expression and condition to respective abstract expression and condition in abstract ordered choice construct extension is required.”).

The definition of the construct is within syntactic boundaries of an enclosing construct. The enclosing construct is at least one of a type, a struct, a function and a nested second construct.

The following code snippet illustrates an “ordered_choice_based_on” construct, an ordered-choice construct whose conditions are based on an input list of variables specified in the choice based on construct definition.
1 q :: ordered_choice_based_on(<input_list_of_variables>)
2 conditions based on input_list_of_variables

### Code 1: Ordered Choice Based on Construct

A second code snippet Code 2 provides an example in which a variable “q” is an ordered choice_based_on construct (line 1) whose conditions are based on an input list of variables “a”, “b” and “c”. Lines 2 to 7 are the conditional blocks of “q”.
1 q :: ordered_choice_based_on(a, b, c)
2 a>100=>
3 b*c
4 a>b and? a>c=>
5 42
6 default=>
7 a*b/c

### Code 2: Ordered Choice Based On a, b, and c

When the compiler encounters a condition in the ordered_choice_based_on construct that is not based on the input list of variables, it throws an error. If a condition for ordered_choice_based_on construct “q” is not based on “a”, “b” and “c” types, then the compiler throws an error. The input list of variables can be a singleton, sequence, or a set of elements or objects. For example, q=ordered_choice_based_on(a[], b{}, c) where “a[]” is a sequence and “b{}” is a set. The specific data type can also be a slice of a sequence, for example, choice_based_on(a[1 . . . 5]) where the conditions should be based on the first five elements of sequence “a”.

In ordered_choice_based_on construct extensions, the compiler checks if the newly added conditions involve only the list of variables given in the construct definition. If a new condition in an extension involves a variable outside of the input list, then the compiler throws an error. The default condition handling as described in Default condition management for ordered-choice construct is also applicable to ordered_choice_based_on construct.

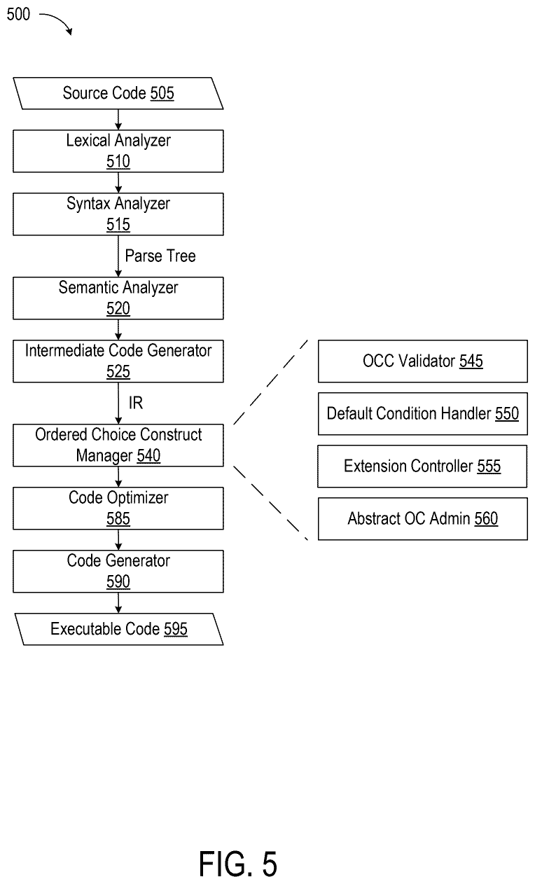

FIG. 5 is a flowchart 500 illustrating how a compiler can compile ordered-choice constructs in source code 505. The compiler operates on a general-purpose computing device with a processor, memory, and storage familiar to those of skill in the art. A detailed discussion of this hardware is omitted for brevity.

A lexical analyzer 510 performs lexical analysis, also known as scanning, where source code 505 is converted into a sequence of lexical units or tokens. Tokens are the smallest meaningful units of a programming language, such as keywords, identifiers, operators, and literals.

A syntax analyzer 515 performs syntax analysis, also known as parsing, where the compiler checks whether the sequence of tokens generated by the lexical analyzer 510 conforms to the rules defined by the programming language's grammar. This analysis typically involves constructing a parse tree or syntax tree that represents the hierarchical structure of the source code.

A semantic analyzer 520 performs semantic analysis where the compiler examines the meaning of the statements and expressions in the source code beyond their syntactic structure. During semantic analysis, the compiler checks for semantic correctness, such as type compatibility, undeclared variables, and adherence to language-specific constraints. Analyzer 520 also performs various optimizations and transformations based on the semantic properties of the code.

An intermediate code generator 525 generates an IR of the source code after semantic analysis and optimization, but before the final machine code. Often during intermediate code generation, the compiler translates high-level source code into an IR that is closer to the target machine language but still independent of the target machine architecture. This intermediate code is typically in the form of low-level instructions or an intermediate language. The main purpose of intermediate code generation is to provide a platform-independent representation of the source code that facilitates further optimization and simplifies the task of generating machine code for different target architectures. A variety of compiling processes may be applied to code in intermediate form. An IR may include one or more of any of a variety of forms, including but not necessarily a control flow graph, static single assignment, three-address code, an abstract syntax tree, and the like.

The IR can be any applicable data structure. In the example of FIG. 5, the parse tree is represented distinctly from the IR, but a parse tree can itself be an IR, in which case IR intermediate code generation 525 is optional. The IR can also be a graph, a hybrid of a tree and a graph, or some other applicable data structure. Likewise, the parse tree (or “parse structure”) can be implemented as a graph, hybrid of a tree and graph, or some other applicable data structure. The generated IR is given as an input to construct manager 540 to provide an ordered-choice-construct-managed IR, which is then treated to code optimization 585 for validation and improved performance. Later, the optimized IR is sent to the code generator (590) to create an executable specific to the target processor. Compiler support for order-choice construct management may be implemented in similar ways over various phases and passes of compilation using the principles described herein.

An ordered-choice-construct manager 540 receives the IR and validates ordered-choice constructs as noted previously in connection with FIG. 2B. Construct manager 540 includes an ordered-choice-construct (OCC) validator 545, an ordered-choice default condition handler 550, an OCC extension controller 555, and an abstract-ordered-choice administrator 560.

OCC validator 545 identifies the execution order of new conditional statement (k) of an ordered choice in an OCC extension. Validator 545 then generates an execution sequence of conditional statements of the ordered choice defined within the construct definition and in the extension based on the value of k in the IR. The compiler throws an error when the condition of an ordered_choice_based_on construct is not based on the input list of variables.

Default condition handler 550 checks whether the conditions of an ordered-choice construct cover all the cases to decide whether the default condition is required. Compiler 500 throws an error asking the developer to provide the “default” condition if the specified conditions do not cover all cases. Handler 550 also checks whether the default conditional block is required in the IR for the ordered-choice-construct when considered along with its extensions within a file or in different files.

Extension controller 555 manages the extension of ordered-choice constructs within a file and in different files and the extension of ordered_choice_based_on constructs by checking whether newly added conditions involve only the involve only the input list of variables given in the construct definition and otherwise throws an error.

Abstract ordered-choice administrator 560 responds to abstract ordered-choice constructs by checking whether an extension provides a condition for an abstract condition and an expression for an abstract expression and otherwise throwing an error.

A code-optimizer 585 improves the IR to enhance its efficiency in terms of execution time, memory usage, or other performance metrics. During code optimization, compiler 500 applies various techniques and transformations to the intermediate code to eliminate redundant operations, minimize resource usage, and improve the overall quality of the generated code.

Optimization techniques may include constant folding, dead code elimination, loop optimization, and many others. The primary goal of code optimization is to produce code that executes more efficiently on the target platform, resulting in improved performance and reduced resource consumption. Other embodiments may employ different or additional compiler phases processing the IR for other purposes.

Code generator 590 translates the optimized IR into executable machine code 595 specific to the target platform. During code generation, the compiler maps the instructions and constructs of the intermediate code to the corresponding machine instructions taking advantage of the specific features and optimizations offered by the target architecture. This process involves generating assembly code or machine code that directly controls the behavior of the target hardware. Code generation may be conducted in multiple phases. For example, llvm may be an intermediate target of code generation 590. An intermediate level compilation can be further processed into executable code 595 for one or more target processors and/or architectures.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Therefore, the spirit and scope of the appended claims should not be limited to the foregoing description. Only those claims specifically reciting “means for” or “step for” should be construed in the manner required under the sixth paragraph of 35 U.S.C. § 112.

1. A method of compiling source code, the method comprising:
encountering in the source code a definition of a construct, the construct including a variable, a first condition to evaluate the variable, and a second condition to evaluate the variable; and
identifying an extension of the construct outside the definition of the construct, the extension including a third condition to evaluate the variable.

2. The method of claim 1, further comprising evaluating at least one of the construct and the extension to determine an execution sequence of the third condition relative to the first and second conditions.

3. The method of claim 2, wherein the extension includes an order indicator and determining the execution sequence comprises considering the order indicator.

4. The method of claim 1, wherein the extension includes a reference to the construct and the identifying includes encountering the reference.

5. The method of claim 1, wherein the definition of the construct assigns a value to the variable.

6. The method of claim 1, wherein each of the first and second conditions comprises a Boolean expression that evaluates to either true or false.

7. The method of claim 1, the construct further including a keyword that indicates a sequential execution of the first, second, and third conditions for evaluating the variable, the method further comprising identifying the keyword in the source code.

8. The method of claim 1, wherein the definition of the construct is within at least one of a type and a struct.

9. The method of claim 1, wherein the definition of the construct is within at least one of a function, a loop, and a nested second construct.

10. The method of claim 1, wherein the definition of the construct extends from a start marker marking a beginning of the construct and an end marker marking an end of the construct.

11. The method of claim 1, further comprising generating an intermediate-level representation of the construct including the extension.

12. The method of claim 1, wherein the extension indicates an order for the third condition.

13. The method of claim 12, further comprising determining an execution sequence for the third condition relative to the first and second conditions responsive to the order.

14. The method of claim 13, wherein the second condition shares the order for the third condition, the method further comprising replacing the second condition with the third condition.

15. The method of claim 14, further comprising validating that the third condition encompasses the second condition before replacing the second condition with the third condition.

16. The method of claim 1, wherein the definition of the construct is within a first file and the extension of the construct is within a second file.

17. The method of claim 16, further comprising encountering an import statement in the extension and referencing the first file.

18. The method of claim 1, wherein the definition of the construct includes an extensibility indicator, the method further comprising verifying the existence of the extensibility indicator.

19. The method of claim 1, further comprising finding one of the first, second, and third conditions redundant with the others of the first, second, and third conditions and omitting the redundant one of the first, second, and third conditions.

20. The method of claim 1, wherein the extension of the construct includes an indicator, the method further comprising identifying the third condition using the indicator.

21. The method of claim 20, further comprising identifying the definition of the construct from a file and identifying a reference to the file using the indicator.

22. The method of claim 20, wherein the indicator includes the variable.

23. The method of claim 1, wherein the definition of the construct is within syntactic boundaries of an enclosing construct.

24. The method of claim 23, wherein the enclosing construct is at least one of a type and struct, and wherein the extension of the construct includes an indicator having at least one of a type name and a struct name referencing the enclosing construct.

25. The method of claim 23, wherein the enclosing construct includes at least one of a function and a nested second construct and the extension includes an indicator that includes at least one of a function name and a nested variable referencing the enclosing construct.

26. The method of claim 1, wherein the construct includes an input list of variables, the method further comprising checking whether the third condition is based on the input list of variables.

27-31. (canceled)
